(19) United States
(12) Patent Application Publication
(10) Pub. No.: US 2017/0280385 A1
(43) Pub. Date: Sep. 28, 2017

(54) LINK SPEED CONTROL SYSTEMS FOR POWER OPTIMIZATION

(71) Applicant: QUALCOMM Incorporated, San Diego, CA (US)

(72) Inventors: Neven Klacar, Encinitas, CA (US); Murali Krishna, San Diego, CA (US); Shailesh Maheshwari, San Diego, CA (US); Suyash Ranjan, San Diego, CA (US); Ofer Rosenberg, San Diego, CA (US)

(21) Appl. No.: 15/465,984

(22) Filed: Mar. 22, 2017

Related U.S. Application Data
(60) Provisional application No. 62/312,303, filed on Mar. 23, 2016.
(60) Provisional application No. 62/417,902, filed on Nov. 4, 2016.

(51) Int. Cl. H04W 52/02; G06F 1/32; H04L 12/24

(52) U.S. Cl. CPC H04W 52/0209; H04L 41/083; H04L 41/0833; G06F 1/3296

(57) ABSTRACT

Link speed control systems for power optimization are disclosed. In one aspect, a communication link adjusts a data transfer speed based on link utilization levels. In a second exemplary aspect, one or more conditions affecting a link speed are weighted and collectively evaluated to determine an efficient or optimal link speed. By adjusting the link speed in this fashion, lower link speeds may be used, and net power savings may be effectuated.

### PRIORITY CLAIMS

The present application claims priority to U.S. Provisional Patent Application Ser. No. 62/312,303 filed on Mar. 23, 2016 and entitled “DYNAMIC PCIE LINK SPEED RATE CHANGE FOR OPTIMAL POWER SAVINGS,” the contents of which is incorporated herein by reference in its entirety.

The present application also claims priority to U.S. Provisional Patent Application Ser. No. 62/417,902, filed on Nov. 4, 2016 and entitled “ALGORITHM FOR CHANGING LINK SPEED FOR POWER OPTIMIZATION,” the contents of which is incorporated herein by reference in its entirety.

### BACKGROUND

I. Field of the Disclosure

The technology of the disclosure relates generally to high-speed data communication, and more particularly to power optimization on communication links for high-speed data communication.

II. Background

Electronic devices such as cellular telephones, modems, computers, digital music players, gaming devices, and the like have become a part of everyday life. Small computing devices are now placed in everything from automobiles to housing locks and have increasingly become more complex. For example, many electronic devices have one or more processors that help control the device, as well as a number of digital circuits to support the processor and other parts of the device. An electronic device may include multiple integrated circuits (ICs) which require board-level interconnects for communication and operational coordination.

High-speed interfaces are typically used between ICs and components of such mobile computing devices and other complex computing apparatus. For example, certain devices may include processing, communication, storage, and/or display devices that interact with one another through communication links. While some of these communication links may be high speed, others may not need to support such high speeds. For example, some of these components, including synchronous dynamic random access memory (SDRAM), may be capable of providing or consuming data and control information at processor clock rates (i.e., high speed). In contrast, other components, such as display controllers, may require variable amounts of data at relatively low video refresh rates.

Peripheral Component Interconnect (PCI) express (PCIe) is a serial expansion bus standard for connecting a device to one or more peripheral devices. While PCIe is a point-to-point standard, one device may be coupled to multiple devices through multiple PCIe buses or through a hub or switch. PCIe provides lower latency and higher data transfer rates compared to parallel buses. Peripheral devices that use PCIe for data transfer include graphics adapter cards, network interface cards (NICs), storage accelerator devices, and other high-performance peripherals.

Mobile computing devices typically rely on a battery for power. High-speed communication buses such as PCIe buses may consume relatively large amounts of power, and as frequencies on such high-speed communication buses increases, power consumption also increases. Consumer demand for longer battery life has placed pressure on device makers to find ways to reduce power consumption.

### SUMMARY OF THE DISCLOSURE

Aspects disclosed in the detailed description include link speed control systems for power optimization. In a first exemplary aspect, a communication link adjusts a data transfer speed based on link utilization levels. In a second exemplary aspect, one or more conditions affecting a link speed are weighted and collectively evaluated to determine an efficient or optimal link speed. By adjusting the link speed in this fashion, lower link speeds may be used, and net power savings may be effectuated.

In this regard in one aspect, a first device for changing a link speed is disclosed. The first device includes a communication interface circuit. The first device also includes a processing circuit. The processing circuit is configured to establish a link with a second device via the communication interface circuit. The processing circuit is also configured to detect one or more conditions affecting a link speed. Each of the one or more conditions is assigned a weight. The processing circuit is also configured to select an optimal link speed for communicating on the link based on the one or more conditions by evaluating a priority of each condition according to the weight assigned to each condition. The processing circuit is also configured to negotiate with the second device to change to the optimal link speed for communicating on the link.

In another aspect, a method of changing a link speed at a first device is disclosed. The method includes establishing a link with a second device. The method also includes detecting one or more conditions affecting a link speed. Each of the one or more conditions is assigned a weight. The method also includes selecting an optimal link speed for communicating on the link based on the one or more conditions by evaluating a priority of each condition according to the weight assigned to each condition. The method also includes negotiating with the second device to change to the optimal link speed for communicating on the link.

In another aspect, a first device for changing a link speed is disclosed. The first device includes means for establishing a link with a second device. The first device also includes means for detecting one or more conditions affecting a link speed. Each of the one or more conditions is assigned a weight. The first device also includes means for selecting an optimal link speed for communicating on the link based on the one or more conditions by evaluating a priority of each condition according to the weight assigned to each condition. The first device also includes means for negotiating with the second device to change to the optimal link speed for communicating on the link.

In another aspect, a first device for changing a link speed is disclosed. The first device includes a communication interface circuit. The first device also includes a processing circuit. The processing circuit is configured to, via the communication interface circuit, establish a link with a second device. The processing circuit is also configured to utilize an amount of resources for operating the link. The amount of the resources corresponds to a link speed. The processing circuit is also configured to negotiate with the second device to change to a low system throughput state based on at least one condition. The processing circuit is also configured to reduce the link speed based on the change to the low system throughput state. The processing circuit is also configured to reduce the amount of the resources utilized for operating the link corresponding with the reduced link speed.

In another aspect, a method of changing a link speed at a first device is disclosed. The method includes establishing a link with a second device. The method also includes utilizing an amount of resources for operating the link. The amount of the resources corresponds to a link speed. The method also includes negotiating with the second device to change to a low system throughput state based on at least one condition. The method also includes reducing the link speed based on the change to the low system throughput state. The method also includes reducing the amount of the resources utilized for operating the link corresponding with the reduced link speed.

In another aspect, a first device for changing a link speed is disclosed. The first device includes means for establishing a link with a second device. The first device also includes means for utilizing an amount of resources for operating the link. The amount of the resources corresponds to a link speed. The first device also includes means for negotiating with the second device to change to a low system throughput state based on at least one condition. The first device also includes means for reducing the link speed based on the change to the low system throughput state. The first device also includes means for reducing the amount of the resources utilized for operating the link corresponding with the reduced link speed.

In another aspect, a processor-readable storage medium is disclosed. The processor-readable storage medium has one or more instructions which, when executed by at least one processing circuit of a first device, cause the at least one processing circuit to establish a link with a second device. The one or more instructions also cause the at least one processing circuit to utilize an amount of resources for operating the link. The amount of the resources corresponds to a link speed. The one or more instructions also cause the at least one processing circuit to negotiate with the second device to change to a low system throughput state based on at least one condition. The one or more instructions also cause the at least one processing circuit to reduce the link speed based on the change to the low system throughput state. The one or more instructions also cause the at least one processing circuit to reduce the amount of the resources utilized for operating the link corresponding with the reduced link speed.

In another aspect, a first device for changing a link speed is disclosed. The first device includes a memory. The first device also includes a processing circuit coupled to the memory. The processing circuit is configured to establish a link with a second device. The processing circuit is also configured to utilize an amount of resources for operating the link. The amount of the resources corresponds to a link speed. The processing circuit is also configured to negotiate with the second device to change to a high system throughput state based on at least one condition. The processing circuit is also configured to increase the amount of the resources utilized for operating the link based on the change to the high system throughput state. The processing circuit is also configured to increase the link speed corresponding with the increased amount of the resources.

In another aspect, a method for changing a link speed of a first device is disclosed. The method includes establishing a link with a second device. The method also includes utilizing an amount of resources for operating the link. The amount of the resources corresponds to a link speed. The method also includes negotiating with the second device to change to a high system throughput state based on at least one condition. The method also includes increasing the amount of the resources utilized for operating the link based on the change to the high system throughput state. The method also includes increasing the link speed corresponding with the increased amount of the resources.

In another aspect, a first device for changing a link speed is disclosed. The first device includes means for establishing a link with a second device. The first device also includes means for utilizing an amount of resources for operating the link. The amount of the resources corresponds to a link speed. The first device also includes means for negotiating with the second device to change to a high system throughput state based on at least one condition. The first device also includes means for increasing the amount of the resources utilized for operating the link based on the change to the high system throughput state. The first device also includes means for increasing the link speed corresponding with the increased amount of the resources.

In another aspect, a processor-readable storage medium is disclosed. The processor-readable storage medium has one or more instructions which, when executed by at least one processing circuit of a first device, cause the at least one processing circuit to establish a link with a second device. The one or more instructions also cause the at least one processing circuit to utilize an amount of resources for operating the link. The amount of the resources corresponds to a link speed. The one or more instructions also cause the at least one processing circuit to negotiate with the second device to change to a high system throughput state based on at least one condition. The one or more instructions also cause the at least one processing circuit to increase the amount of the resources utilized for operating the link based on the change to the high system throughput state. The one or more instructions also cause the at least one processing circuit to increase the link speed corresponding with the increased amount of the resources.

In another aspect, an integrated circuit (IC) is disclosed. The IC includes resource circuitry. The IC also includes a port configured to be coupled to a communication link and operatively coupled to the resource circuitry. The resource circuitry is used to control aspects of communication over the communication link. The IC also includes a host configured to adjust activity over the communication link based on one or more conditions affecting the communication link.

### BRIEF DESCRIPTION OF THE FIGURES

FIG. 1 is a simplified representation of a mobile computing device that may include a communication link between elements therewithin that may include the link speed control systems of the present disclosure;

FIG. 2 is a block diagram of elements within a computing device coupled by a communication link that may have its link speed controlled according to the link speed control systems of the present disclosure;

FIG. 3 is a diagram illustrating a relationship between a link speed and power used to operate a device at the link speed;

FIG. 4 is a flowchart illustrating a method of changing a link speed to a lower speed according to an exemplary aspect of the present disclosure;

FIG. 5 is a flowchart illustrating a method of changing a link speed to a higher speed according to an exemplary aspect of the present disclosure;

FIG. 6 is a block diagram of a system having two link partners connected by a communication link capable of having a link speed manipulated thereon according to a link speed control system;

FIG. 7 is a block diagram illustrating examples of circuits/modules implementing method for changing a link speed according to weighted inputs according to one or more exemplary aspects of the present disclosure; and

FIG. 8 is a flowchart illustrating a method of changing a link speed according to weighted inputs according to a further exemplary aspect of the present disclosure.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include link speed control systems for power optimization. In a first exemplary aspect, a communication link adjusts a data transfer speed based on link utilization levels. In a second exemplary aspect, one or more conditions affecting a link speed are weighted and collectively evaluated to determine an efficient or optimal link speed. By adjusting the link speed in this fashion, lower link speeds may be used, and net power savings may be effectuated.

It should be appreciated that the power savings comes not only from using a lower frequency on the link, but also by allowing the terminus to enter a lower power state than might otherwise be available. That is, if the terminus has to maintain an active high voltage to send data at a higher rate, the terminus may not be allowed to enter a low power state. However, if the rate is lowered, and the voltage correspondingly lowered, the terminus may allow itself to enter a low power state. Having an entire chip associated with the terminus enter a low power state may provide significant power savings.

Aspects of the present disclosure relate to dynamically changing a speed of a Peripheral Component Interconnect (PCI) express (PCIe) link to optimally save device power. The PCIe specification allows for three different link speeds. PCIe GEN1 allows for two and a half gigatransfers per second (2.5 GT/s), PCIe GEN2 allows for five (5) GT/s, and PCIe GENS allows for eight (8) GT/s. During link training, each link partner may advertise a supported link speed (e.g., maximum link speed) and agree upon a link speed at which to operate. For example, the link partners may agree to operate at the highest link speed supported by both partners. The link partners may initially train at a lowest speed and then transition up to a fastest speed. If the PCIe link is stable, the link partners will continue to operate at the fastest speed. If the PCIe link is not stable, the link partners will re-negotiate down to a lower speed. Hence, the link partners may change the link speed to a lower rate for link stability reasons. In an example, the link speed may be changed autonomously by hardware.

As the link speed increases, a required power to operate the PCIe link also increases. However, not all use cases are equal with regard to link utilization. At times where link activity is low, a lower link speed may be sufficient. As such, working at a reduced link speed may enable a System-on-Chip (SoC) to consume less power during low-activity periods. For low throughput use cases where the PCIe link is utilized infrequently, a faster link speed can be detrimental to power. However, for higher throughput use cases that result in higher link utilization, the faster link speed may result in lower power use compared to a slower link speed. Accordingly, the present disclosure provides a solution for optimally saving device power used to operate a link by facilitating a device to dynamically change a link speed based on use case requirements.

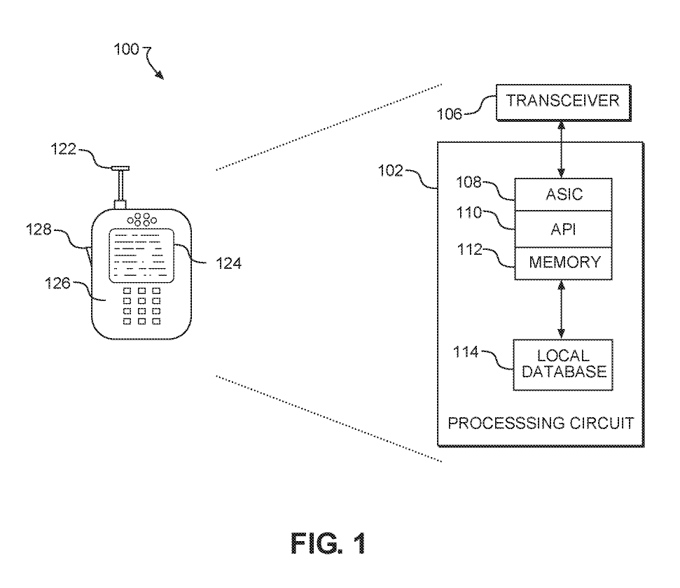

It should be appreciated that the present disclosure is well suited for use with a PCIe link. While other communication links may also benefit from the present disclosure, for the purposes of illustration, the present disclosure will use a PCIe link as the illustrated example. Accordingly, a brief overview of a computing device and a PCIe link and its operation in a computing device is provided with reference to FIGS. 1-3.

Certain aspects of the present disclosure may be applicable to communications links deployed between electronic components, which may include subcomponents of devices such as telephones, mobile computing devices, appliances, automobile electronics, avionics systems, etc. Referring to FIG. 1, for example, an apparatus 100 for dynamically changing a link speed may include a processing circuit 102 that is configured to control operation of the apparatus 100. The processing circuit 102 may access and execute software applications and control logic circuits and other devices within the apparatus 100. In one example, the apparatus 100 may include a communication device that communicates through a radio frequency (RF) communications transceiver 106 with a radio access network (RAN), a core access network, the Internet, and/or another network. The RF communications transceiver 106 may be operably coupled to the processing circuit 102. The processing circuit 102 may include one or more integrated circuit (IC) devices, such as an application specific integrated circuit (ASIC) 108. The ASIC 108 may include one or more processing devices, logic circuits, and so on. The processing circuit 102 may include and/or be coupled to processor-readable storage 112 that may maintain instructions and data that may be executed by the processing circuit 102. The processing circuit 102 may be controlled by one or more of an operating system and an application programming interface (API) 110 layer that supports and enables execution of software modules residing in the processor-readable storage 112 of the device. The processor-readable storage 112 may include read only memory (ROM) or random access memory (RAM), electrically erasable programmable read only memory (EEPROM), a flash memory device, or any memory device that can be used in processing systems and computing platforms. The processing circuit 102 may include and/or access a local database 114 that can maintain operational parameters and other information used to configure and operate the apparatus 100. The local database 114 may be implemented using one or more of a database module or server, flash memory, magnetic media, EEPROM, optical media, tape, soft or hard disk, or the like. The processing circuit 102 may also be operably coupled to external devices such as an antenna 122, a display 124, and operator controls, such as a keypad 126 and a button 128, among other components.

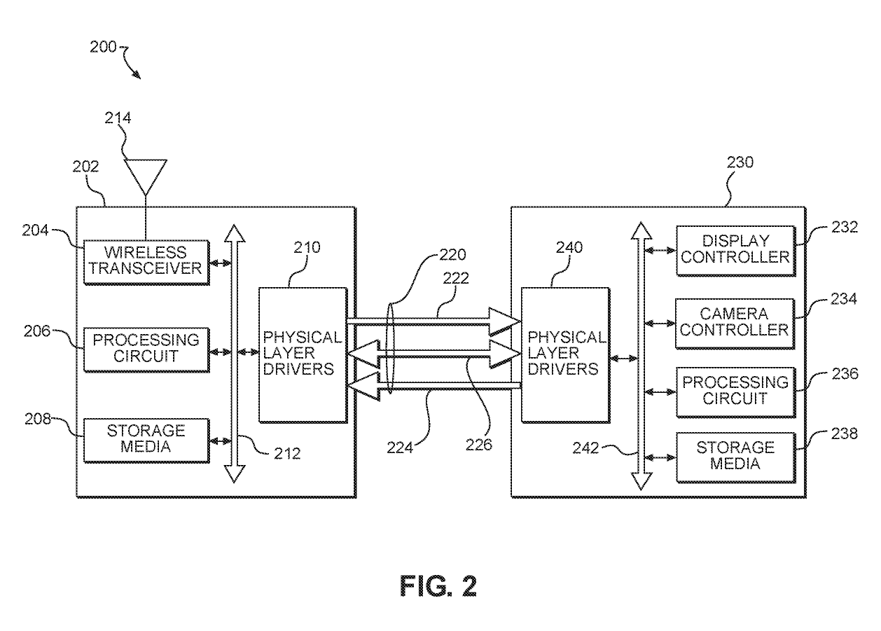

FIG. 2 is a block schematic illustrating certain aspects of an apparatus 200 such as a mobile device, a mobile telephone, a mobile computing system, a telephone, a notebook computer, a tablet computing device, a media player, a gaming device, or the like. The apparatus 200 may include a plurality of IC devices such as a first IC device 202 and a second IC device 230 that exchange data and control information through a communication link 220. The communication link 220 may be used to connect the IC devices 202 and 230, which may be located in close proximity to one another or physically located in different parts of the apparatus 200. In one example, the communication link 220 may be provided on a chip carrier, substrate, or circuit board that carries the IC devices 202 and 230. In another example, the first IC device 202 may be located in a keypad section of a flip-phone while the second IC device 230 may be located in a display section of the flip-phone. A portion of the communication link 220 may include a cable or an optical connection.

The communication link 220 may include multiple channels 222, 224 and 226. One or more of the channels 226 may be bidirectional, and may operate in a half-duplex mode and/or a full-duplex mode. One or more of the channels 222, 224 may be unidirectional. The communication link 220 may be asymmetrical, providing higher bandwidth in one direction. In one example described herein, a first communication channel of the channels 222 may be referred to as a forward link 222 while a second communication channel of the channels 224 may be referred to as a reverse link 224. The first IC device 202 may be designated as a host, master, and/or transmitter, while the second IC device 230 may be designated as a client, slave, and/or receiver, even if both of the IC devices 202 and 230 are configured to transmit and receive on the communication link 220. In one example, the forward link 222 may operate at a higher data rate when communicating data from the first IC device 202 to the second IC device 230, while the reverse link 224 may operate at a lower data rate when communicating data from the second IC device 230 to the first IC device 202.

The IC devices 202 and 230 may each include a processor or other processing and/or computing circuit or device 206, 236. In one example, the first IC device 202 may perform core functions of the apparatus 200, including maintaining communications through a transceiver 204 and an antenna 214, while the second IC device 230 may support a user interface that manages or operates a display controller 232, and may control operations of a camera or video input device using a camera controller 234. Other features supported by one or more of the IC devices 202 and 230 may include a keyboard, a voice-recognition component, and other input or output devices. The display controller 232 may include circuits and software drivers that support a display such as a liquid crystal display (LCD) panel, a touch-screen display, an indicator, and so on. Storage media 208 and 238 may include transitory and/or non-transitory storage devices adapted to maintain instructions and data used by the respective processing circuits 206 and 236, and/or other components of the IC devices 202 and 230. Communication between each of the processing circuits 206, 236 and the corresponding storage media 208 and 238 and other modules and circuits may be facilitated by one or more buses 212 and 242, respectively.

The reverse link 224 may be operated in the same manner as the forward link 222. The forward link 222 and the reverse link 224 may be capable of transmitting at comparable speeds or at different speeds, where speed may be expressed as a data transfer rate and/or a clocking rate. The forward and reverse data rates may be substantially the same or may differ by orders of magnitude, depending on the application. In some applications, a single bidirectional link, such as one of the channels 226 may support communications between the first IC device 202 and the second IC device 230. The forward link 222 and/or the reverse link 224 may be configurable to operate in a bidirectional mode when, for example, the forward and reverse links 222 and 224 share the same physical connections and operate in a half-duplex manner

In certain examples, the reverse link 224 derives a clocking signal from the forward link 222 for synchronization purposes, for control purposes, to facilitate power management, and/or for simplicity of design. The clocking signal may have a frequency that is obtained by dividing the frequency of a symbol clock used to transmit signals on the forward link 222. The symbol clock may be superimposed or otherwise encoded in symbols transmitted on the forward link 222. The use of a clocking signal that is a derivative of the symbol clock allows fast synchronization of transmitters and receivers (transceivers 210, 240) and enables fast start and stop of data signals without the need for framing to enable training and synchronization.

In certain examples, a single bidirectional link, such as one of the channels 226 may support communications between the first IC device 202 and the second IC device 230. In some instances, the first IC device 202 and the second IC device 230 provide encoding and decoding of data, address, and control signals transmitted between a processing device and memory devices such as dynamic RAM (DRAM).

In an exemplary aspect, the communication link 220 is a PCIe link. A connection between any two PCIe devices is referred to as a link. A PCIe link is built around a bidirectional, serial (1-bit) point-to-point connection referred to as a lane. With PCIe, data is transferred over two signal pairs. That is, there are two wires for transmitting and two wires for receiving. The transmitting and receiver pairs are separate different-pairs for a total of four data wires per lane. The lane encompasses a set of signal pairs, and each lane is capable of sending and receiving eight-bit data packets simultaneously between the two points. A PCIe link can scale from one to thirty-two (32) separate lanes. Usual deployments may include 1, 2, 4, 8, 12, 16, or 32 lanes, which may be labeled x1, x2, x4, x8, x12, x16, or x32 respectively, where the number is effectively the number of lanes. In an example, a PCIe x1 implementation would require four wires to connect the two points while a PCIe x16 implementation would require sixty-four wires (4×16). In the event that the communication link 220 is a PCIe link, there is no bidirectional link, and the forward link 222 is at least a two-wire differential link, and the reverse link 224 is likewise at least a two-wire differential link.

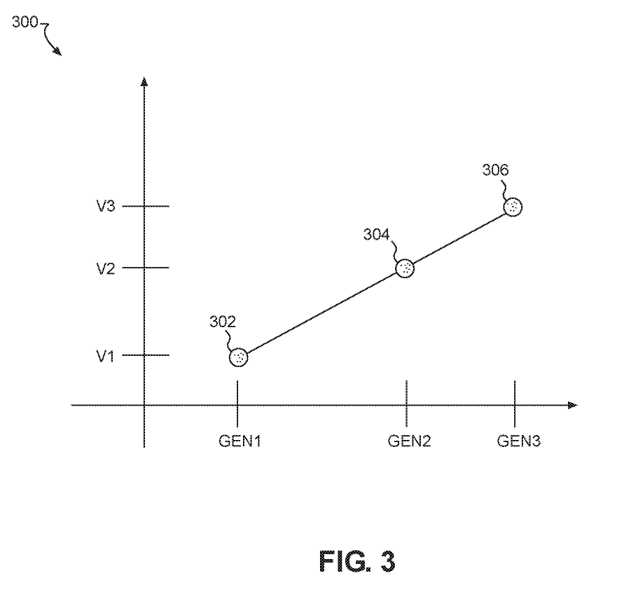

FIG. 3 is a diagram 300 illustrating an abstracted relationship between a link speed and a power used to operate a device such as IC device 202 at the link speed. Hardware within the IC device may be designed to work at a specific frequency and/or voltage. When the frequency at which the hardware works is reduced, the voltage applied to the hardware can be reduced by some factor without damaging the hardware functionality. The factor may vary depending on a process, type of logic, etc., used by the hardware.

For PCIe, the hardware voltage working point may be determined by a maximum frequency, which is driven from a link speed. The PCIe specification allows for three different link speeds: 1) GEN1 allows for 2.5 GT/s; 2) GEN2 allows for 5 GT/s; and 3) GEN3 allows for 8 GT/s. Referring to FIG. 3, hardware designed to work at a GEN1 link speed operates at a voltage V1 302. Hardware designed to work at a GEN2 link speed operates at a voltage V2 304. Hardware designed to work at a GEN3 link speed operates at a voltage V3 306. In an exemplary implementation, when the link speed is increased due to a high level of link activity, hardware capable of working at the GEN1 link speed (at the voltage V1 302) may actually operate at the voltage V3 306 as required by the increased link speed. However, when a level of link activity is low, maintaining hardware operation at the voltage V3 306 may be wasteful if operation at the lower voltage V1 302 is sufficient to support the level of link activity. Accordingly, the link speed may be dynamically changed (e.g., decreased), and a corresponding operating voltage may be lowered, to optimally save power when the level of link activity is low. As noted above, if the first IC device 202 can use V1 302 instead of V3 306, the first IC device 202 may, as a whole, enter a lower power state than if V3 306 must be made available. By putting the entirety of the first IC device 202 power savings are also effectuated.

According to aspects of the present disclosure, two devices coupled by a communication link (e.g., the first IC device 202 coupled to the second IC device 230 through the communication link 220 of FIG. 2) may negotiate a change to a low system throughput state and initiate a dynamic switch to lower the link speed during periods of low activity. The devices may also negotiate a change to a high system throughput state and initiate the dynamic switch to raise the link speed during periods of high activity. For example, one link partner may negotiate a change to a system throughput state, initiate a speed change, and limit a highest advertised speed to the other link partner based on a use case. In an aspect of the disclosure, two link partners may negotiate the change to the system throughput state and/or a change to the link speed by exchanging signals with each other in an attempt to agree upon the system throughput state and/or the link speed at which to operate. Thus, both link partners may affect the value to which the system throughput state and/or the link speed is ultimately changed. For example, if a first link partner identifies that the first link partner and a second link partner are capable of operating on the link at a lower link speed, the first link partner may signal the second link partner with a request to lower the system throughput state and/or reduce the link speed. The second link partner may consider the request and provide a signal response to the first link partner indicating whether the second link partner agrees to operate at the lowered system throughput state and/or the reduced link speed.

In an exemplary aspect of the present disclosure, a device (e.g., link partner) is facilitated to negotiate a system throughput state change and dynamically switch the link speed by monitoring a level of link utilization. The monitoring may be enabled by a firmware or software protocol operating over the PCIe link. If active state link power management (ASPM) is enabled, the PCIe link will be in an inactive link state when not in use. A driver or hardware can activate a timer programmed to monitor the PCIe link and count how long the PCIe link stays inactive. The timer is reset and disabled each time the PCIe link goes back to an active link state. Upon entry back into the inactive link state, the timer begins counting again. Once the timer reaches a pre-defined time and/or exceeds a threshold, a system throughput state can be lowered via negotiation and a target speed of the PCIe link can be reduced.

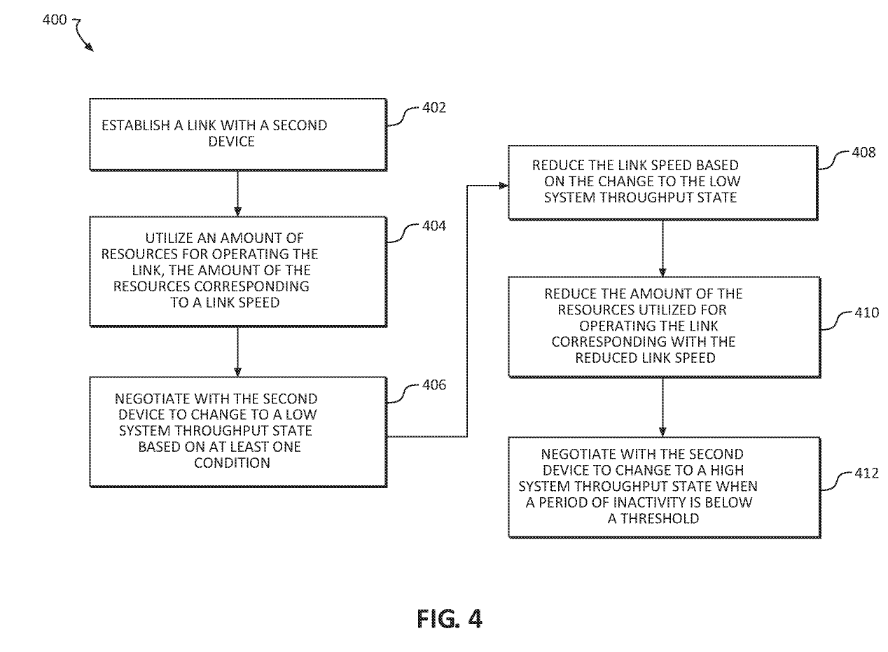

In this regard, FIG. 4 is a flowchart illustrating a method 400 for negotiating the link speed change. The method 400 may be performed by a first device (e.g., the apparatus 100 of FIG. 1, first IC device 202 of FIG. 2, second IC device 230 or the like). The first device establishes a link with a second device (block 402) and utilizes an amount of resources for operating the link (block 404). The amount of the resources may correspond to a link speed and/or a system throughput state. The resources may include voltage resources, frequency resources, and/or other types of resources.

The first device negotiates with the second device to change to a low system throughput state based on at least one condition (block 406). For example, the first device may negotiate with the second device to suspend traffic or cease communication with each other. It should be appreciated that the negotiation is based on known or anticipated use of the link. In an exemplary aspect of the present disclosure, the first device negotiates to change to the low system throughput state by measuring a period of inactivity on the link and negotiating to change to the low system throughput state when the period of the inactivity exceeds a threshold. In another exemplary aspect of the present disclosure, the first device negotiates to change to the low system throughput state by determining a link state including a current link bandwidth requirement and/or a link connection status, and negotiating to change to the low system throughput state based on the link state.

The first device reduces the link speed based on the change to the low system throughput state (block 408). This may include advertising the reduced link speed to the second device. The first device reduces the amount of the resources utilized for operating the link corresponding with the reduced link speed (block 410). The first device may further negotiate with the second device to change to a high system throughput state when the period of the inactivity on the link is below the threshold (block 412).

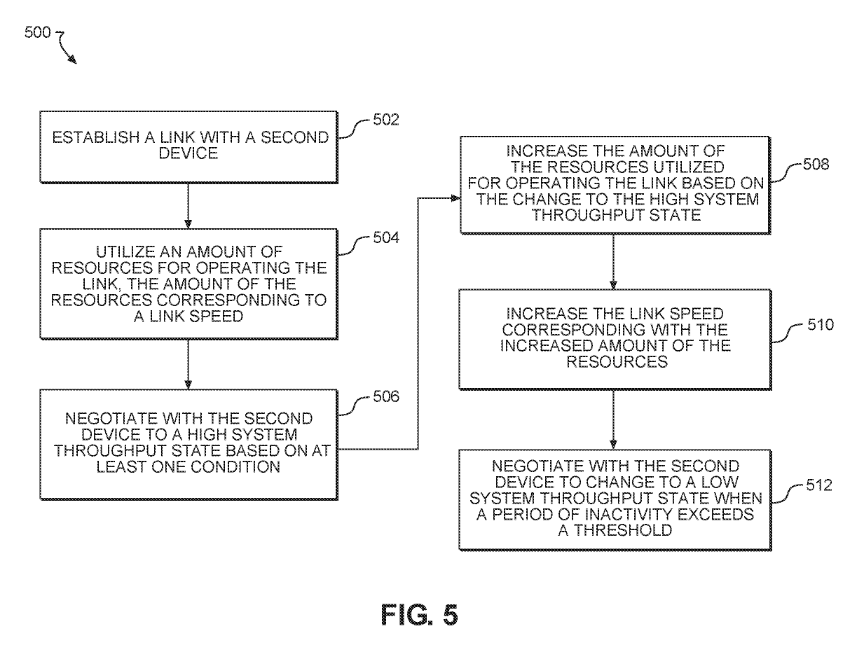

FIG. 5 is a flowchart 500 illustrating another method of changing a link speed. The method may be performed by a first device (e.g., the apparatus 100 of FIG. 1, the first IC device 202 of FIG. 2, or the second IC device 230).

The first device establishes a link with a second device (block 502) and utilizes an amount of resources for operating the link (block 504). The amount of the resources may correspond to a link speed and/or a system throughput state. The resources may include voltage resources, frequency resources, and/or other types of resources. The first device negotiates with the second device to change to a high system throughput state based on at least one condition (block 506). For example, the first device may negotiate with the second device to increase traffic or begin communication with each other. It should be appreciated that the negotiation is based on known or anticipated use of the link. In an exemplary aspect of the present disclosure, the first device negotiates to change to the high system throughput state by receiving a request to change to the high system throughput state. In another exemplary aspect of the present disclosure, the first device negotiates to change to the high system throughput state by measuring a period of inactivity on the link and negotiating to change to the high system throughput state when the period of the inactivity is below a threshold. In a further aspect of the disclosure, the first device negotiates to change to the high system throughput state by determining a link state, including a current link bandwidth requirement and/or a link connection status, and negotiating to change to the high system throughput state based on the link state.

The first device increases the amount of the resources utilized for operating the link based on the change to the high system throughput state (block 508) and increases the link speed corresponding with the increased amount of the resources (block 510). In an aspect of the disclosure, increasing the link speed may include advertising the increased link speed to the second device. The first device may further negotiate with the second device to change to a low system throughput state when the period of the inactivity on the link exceeds the threshold (block 512).

For example, the device may reduce the target speed of the link according to the following operation: 1) Modify a TARGET_LINK_SPEED field of a LINK_CONTROL_2 register in a PCIe configuration state; 2) Set a directed_speed_change variable advertised in training sets; and 3) Direct the link to a recovery sequence to advertise the new speed change.

Once the link speed is reduced (or after it is increased through a renegotiation pursuant to the method of FIG. 5), the link will operate in the newest advertised link speed even if the link is retrained subsequently. After some time, when the device driver software or hardware starts transferring data again, the system throughput state can again be changed via negotiation, and the link speed change can again be initiated to the highest possible link speed, in order to take full advantage of the link bandwidth.

In another exemplary aspect of the present disclosure, a host device (e.g., first link partner) is facilitated to negotiate a system throughput state change and dynamically switch the link speed by maintaining a high-level protocol for exchanging information with another device (e.g., second link partner). The host device and other device may exchange link state information, such as current bandwidth requirements and/or a connection status (e.g., idle, low, medium, or high activity). For example, if the host device identifies that both sides (host device and other device) are capable of operating on the link at a lower link speed, the host device signals the other device with a request to change to a low system throughput state and/or reduce the link speed. When the link request is approved by the other device, the host device proceeds to change to the low system throughput state and reduce the link speed, e.g., according to a process described above.

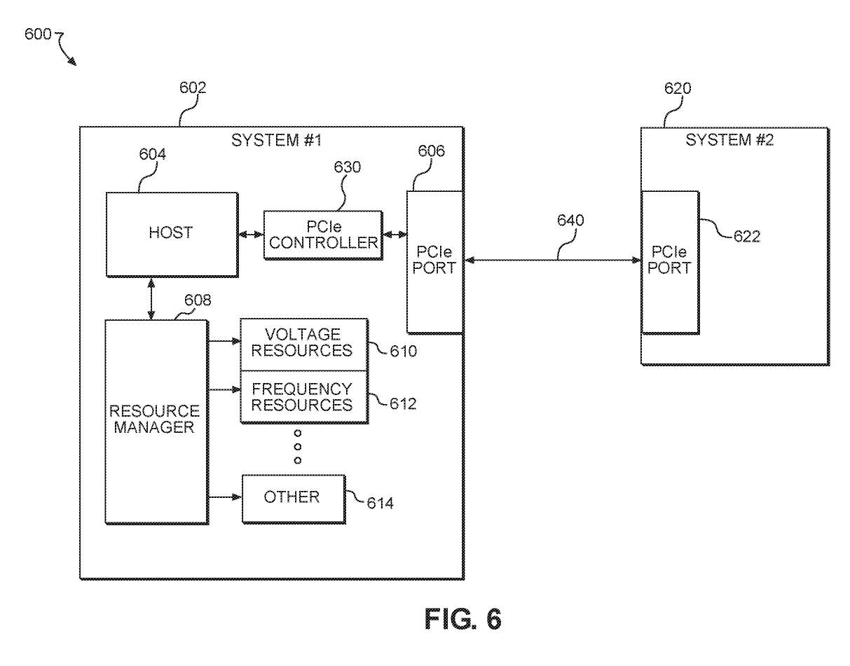

FIG. 6 illustrates a specific PCIe system 600 that may implement the methods of FIGS. 4 and 5. The PCIe system 600 may, for example, be a link between a first link partner (System #1) 602 and a second link partner (System #2) 620. The first link partner 602 may include a host 604, a PCIe port 606, which acts as a communication interface circuit, and a resource manager 608. The resource manager 608 may control various system resources, including voltage resources 610, frequency resources 612, and other resources 614, collectively resource circuitry. The second link partner 620 may include a PCIe port 622, which acts as a communication interface circuit, and other circuits and/or modules not shown similar to the first link partner 602. The first link partner 602 may further include a PCIe controller 630 for managing communication on a PCIe link 640. As shown, the PCIe controller 630 resides between the host 604 and the PCIe port 606. However, in various aspects of the present disclosure, the location of the PCIe controller 630 is not so limited and may be located anywhere within the first link partner 602.

In an exemplary aspect of the present disclosure, an example of a link speed reduction sequence will now be described. Based on the occurrence of a condition, such as the expiration of a timer, or the reception of certain link state information, for example, the host 604 will signal the PCIe port 606 to negotiate to change to a low system throughput state and/or reduce a link speed between the first link partner 602 and the second link partner 620. The PCIe port 606 may then initiate the link speed reduction sequence with the PCIe port 622 of the second link partner 620 based on the change to the low system throughput state. The link speed reduction sequence may include the operations describe above, such as modifying a TARGET_LINK_SPEED field of a LINK_CONTROL_2 register in a PCIe configuration state, setting a directed_speed_change variable advertised in training sets, and directing the PCIe port 622 to a recovery sequence to advertise the new speed change.

When the link speed between the first link partner 602 and the second link partner 620 is successfully reduced, the PCIe port 606 reports the successful link speed reduction to the host 604. The host 604 then negotiates with the resource manager 608 regarding an updated list of required resources for operating the link at the reduced link speed. The updated list may include lower voltage resource requirements, lower frequency resource requirements, and/or other resource requirements. As a result, the resource manager 608 may modify any one of the voltage resources 610, the frequency resources 612, or the other resources 614 based on the updated list, hence lowering the power consumed by the first link partner 602.

In another exemplary aspect of the present disclosure, an example of a link speed increase sequence will now be described. The host 604 may receive a request to negotiate with the second link partner 620 to change to a high system throughput state and/or increase the link speed between the first link partner 602 and the second link partner 620. The host 604 may then negotiate with the resource manager 608 regarding an updated list of required resources for operating the link at the increased link speed and/or the high system throughput state. The updated list may include higher voltage resource requirements, higher frequency resource requirements, and/or other resource requirements.

The resource manager 608 may modify any one of the voltage resources 610, the frequency resources 612, or the other resources 614 based on the updated list and indicate such modification to the host 604. After receiving the indication that the required resources were modified according to the updated list, the host 604 may signal the PCIe port 606 to increase the link speed between the first link partner 602 and the second link partner 620. The PCIe port 606 may then initiate the link speed increase sequence with the PCIe port 622 of the second link partner 620. The link speed increase sequence may include modifying a TARGET_LINK_SPEED field of a LINK_CONTROL_2 register in a PCIe configuration state, setting a directed_speed_change variable advertised in training sets, and directing the PCIe port 622 to a recovery sequence to advertise the new speed change.

Referring to FIGS. 3 and 6 and the related description above, PCIe GEN1, GEN2, and GEN3 link speeds each have specific clock speed requirements as defined in the PCIe specification. Given that there is a significant difference between the respective clock speeds, PCIe controller timing is closed at different voltage levels for different modes of operation. For example, the GEN3 link speed requires the PCIe controller 630 to operate at a highest voltage (e.g., the voltage V3 306) amongst the three link speeds due to a highest clock speed requirement, followed by the GEN2 link speed (e.g., requiring the PCIe controller 630 to operate at the voltage V2 304) and the GEN1 link speed (e.g., requiring the PCIe controller 630 to operate at the voltage V1 302).

To save device cost and area, a power supply of the PCIe controller 630 may be shared with other SoC infrastructure blocks. For low bandwidth or idle scenarios, the PCIe controller 630 operating at the GEN2 or GEN3 link speed (i.e., higher operating voltages) may become a bottleneck and not allow for the lowering of a SoC infrastructure voltage. This leads to unnecessary power loss since maintaining operation at a higher voltage is wasteful if operation at a lower voltage is sufficient to support a low level of link activity. Therefore, what is needed is a method for dynamically switching a PCIe mode of operation based on system requirements that mitigates unnecessary power loss.

According to additional aspects of the present disclosure, methods for dynamically switching a PCIe mode of operation are provided that align the PCIe controller's voltage requirements with a system's voltage requirements without significantly compromising device performance. In an exemplary aspect of the present disclosure, the method considers a set of conditions, which individually or in combination can be used to determine an optimal mode of operation (e.g., the GEN1 link speed, the GEN2 link speed, or the GEN3 link speed) for the PCIe controller 630 to optimize power usage. An advantage of the disclosed method is that the conditions being evaluated for changing the PCIe mode of operation are not very dynamic and are latency tolerant. A system (the first link partner 602 or the second link partner 620) would be able to tolerate latencies in an order of milliseconds (time required for switching the PCIe mode of operation) when changes to the conditions specified in the method occur. Therefore, a negative impact on system performance while changing the PCIe mode of operation based on the conditions is kept to a minimum.

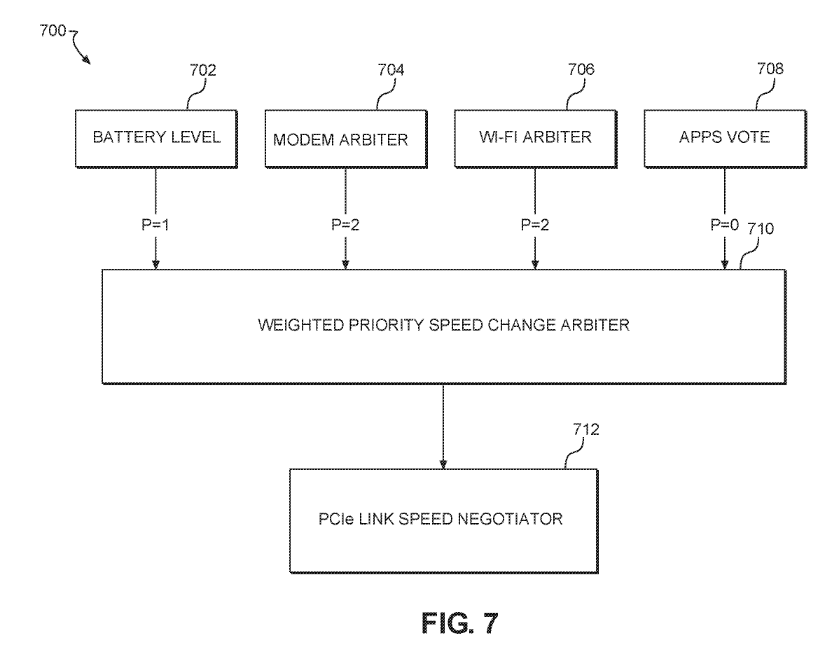

FIG. 7 is a diagram 700 illustrating examples of circuits/modules implementing a method for changing the PCIe mode of operation. In an exemplary aspect of the present disclosure, the method selects a PCIe link speed (e.g., the GEN1 link speed, the GEN2 link speed, or the GEN3 link speed) based on priority inputs/conditions. The method may be implemented by a weighted priority speed change arbiter 710. Upon selecting the PCIe link speed, the weighted priority speed change arbiter 710 signals a PCIe link speed negotiator 712 to negotiate a switch of the PCIe mode of operation to the selected PCIe link speed. The weighted priority speed change arbiter 710 and the PCIe link speed negotiator 712 are circuits/modules that are part of, or operate in connection with, the PCIe controller 630 of the first link partner 602 of FIG. 6.

According to aspects of the present disclosure, the PCIe link speed negotiator 712 (of the first link partner 602) may negotiate with the second link partner 620 to switch to a lower link speed selected by the weighted priority speed change arbiter 710. The PCIe link speed negotiator 712 (of the first link partner 602) may also negotiate with the second link partner 620 to switch to a higher link speed selected by the weighted priority speed change arbiter 710. For example, the first link partner 602 may initiate a link speed change and limit a highest/lowest advertised speed to the second link partner 620 based on the link speed selected by the weighted priority speed change arbiter 710.

In an exemplary aspect of the present disclosure, the first link partner 602 and the second link partner 620 may negotiate the change to the link speed by exchanging signals with each other in an attempt to agree upon the link speed at which to operate. Thus, both link partners may affect the value to which the link speed is ultimately changed. For example, the first link partner 602 may signal the second link partner 620 with a request to change the link speed based on the link speed selected by the weighted priority speed change arbiter 710. The second link partner 620 may consider the request and provide a signal response to the first link partner 602 indicating whether the second link partner 620 agrees to operate at the selected link speed. In another example, the second link partner 620 may signal the first link partner 602 with a request to change the link speed based on a link speed selected by its own weighted priority speed change arbiter. The first link partner 602 may consider the request and provide a signal response to the second link partner 620 indicating whether the first link partner 602 agrees to operate at the selected link speed.

In an exemplary aspect of the present disclosure, one or more priority inputs/conditions may be considered by the weighted priority speed change arbiter 710 when selecting the PCIe link speed. The priority inputs/conditions may include, but are not limited to, battery level information 702, modem technology and configuration information from a modem arbiter 704, maximum available bandwidth information from a wireless fidelity (Wi-Fi) arbiter 706, and a vote 708 from an applications processor.

A battery level of a device may be determined based on a threshold. Accordingly, the battery level information 702 may be input to the weighted priority speed change arbiter 710 to be considered when selecting the PCIe link speed. At lower battery levels, the weighted priority speed change arbiter 710 may decide to restrict the PCIe controller 630 to lower speeds to allow the SoC infrastructure to move to lower voltage levels, and hence save power.

Modem technologies prior to a Long Term Evolution (LTE)/4G communication system may be supported by the GEN1 link speed. For an LTE/4G or 5G communication system, if a modem's configuration does not support a speed of PCIe GEN2 or higher, then the modem may be supported by the GEN1 link speed. Accordingly, the modem technology and configuration information from the modem arbiter 704 may be input to the weighted priority speed change arbiter 710 to be considered when selecting the PCIe link speed.

In discrete Wi-Fi or converged modem Wi-Fi solutions, a Wi-Fi subscription plan may define a maximum available bandwidth for a given user. The user can manually provide the maximum available bandwidth information to a device or the device can derive the information using bandwidth detection. Once available, the maximum available bandwidth information may determine a maximum PCIe link speed that can be supported when Wi-Fi is active. Accordingly, the Wi-Fi arbiter 706 may input the maximum available bandwidth information to the weighted priority speed change arbiter 710 to be considered when selecting the PCIe link speed.

The applications processor may prefer or require a particular PCIe link speed in connection with an application operating on the link. Accordingly, the applications processor may input a direct vote 708 to the weighted priority speed change arbiter 710 to force the PCIe controller 630 to operate at a preferred PCIe link speed (e.g., the GEN1 link speed, the GEN2 link speed, or the GEN3 link speed).

In an exemplary aspect of the present disclosure, the priority inputs/conditions considered by the weighted priority speed change arbiter 710 may each be assigned a weight. For example, higher priority inputs may be given a lower weight value (i.e., zero (0) is a higher weight than one (1), one (1) is a higher weight than two (2), and so on). Thus, as shown in FIG. 7, the battery level information 702 is assigned a weight of one (1) (P=1), the modem technology and configuration information from the modem arbiter 704 is assigned a weight of two (2) (P=2), the maximum available bandwidth information from the Wi-Fi arbiter 706 is assigned a weight of two (2) (P=2), and the vote 708 from the applications processor is assigned a weight of zero (0) (P=0). The weights depicted in FIG. 7 are merely examples as the assigned weights may not be static. In aspects of the present disclosure, a weight assigned to any of the priority inputs/conditions may vary (i.e., the weight may be configurable or programmable). For example, the battery input weight could be two (2) or higher when the battery is fully charged, raised to a one (1) when the battery reaches a half-charged level, and raised to a zero (0) when the battery reaches a 10% charge level. Accordingly, when selecting the PCIe link speed, the weighted priority speed change arbiter 710 may consider the weight of each of the priority inputs/conditions and impart more or less value to an input/condition based on a corresponding weight.

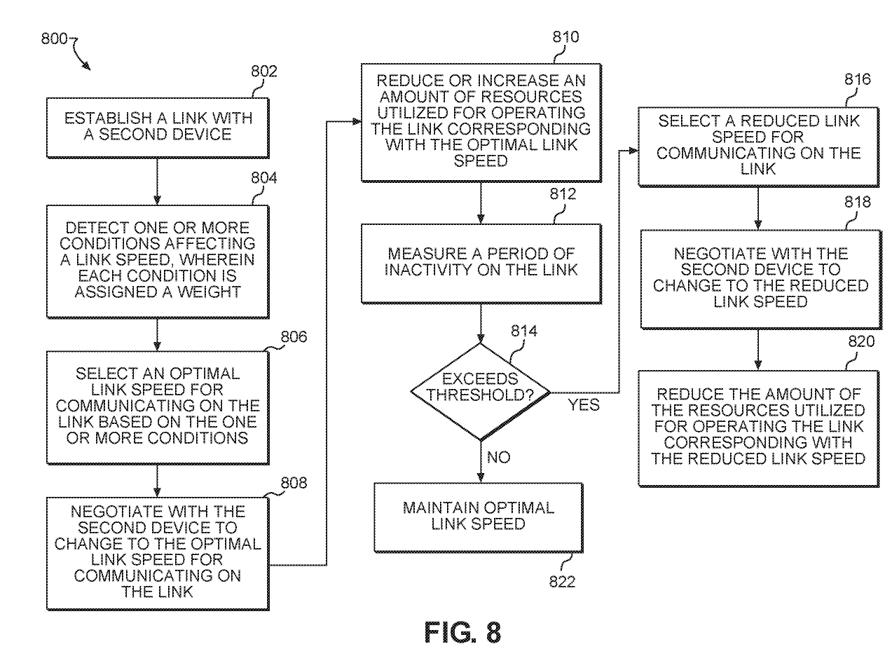

FIG. 8 is a flowchart 800 illustrating a further method of changing a link speed. The method may be performed by a first device (e.g., the apparatus 100 of FIG. 1, the first link partner 602 of FIG. 6, or the second link partner 620 of FIG. 6).

The first device establishes a link with a second device (block 802). For example, the first device may be the first link partner 602, and therefore, may establish the link with the second link partner 620. Similarly, the first device may be the second link partner 620, and therefore, may establish the link with the first link partner 602. Thereafter, the first device detects one or more conditions affecting a link speed (block 804), wherein each of the one or more conditions is assigned a weight. For example, the one or more conditions may include, but are not limited to, battery level information, modem configuration information, maximum available bandwidth information, and/or an applications processor vote. In an exemplary aspect of the present disclosure, the first device assigns the weight to each of the one or more conditions.

The first device selects an optimal link speed for communicating on the link based on the one or more conditions (block 806). In an exemplary aspect, the first device selects the optimal link speed by evaluating a priority/value of each condition according to the weight assigned to each condition. The first device may select the optimal link speed based on an individual condition or a combination of conditions.

After selecting the optimal link speed, the first device may negotiate with the second device to change to the optimal link speed for communicating on the link (block 808). Negotiating with the second device may include advertising the optimal link speed to the second device. The first device may also reduce or increase an amount of resources utilized for operating the link corresponding with the optimal link speed (block 810). For example, the resources may include, but are not limited to, voltage resources and/or frequency resources.

In an exemplary aspect of the present disclosure, the first device may further measure a period of inactivity on the link (block 812) and determine whether the period of the inactivity exceeds a threshold (block 814). If the period of the inactivity exceeds the threshold, then the first device may select a reduced link speed for communicating on the link (block 816) and negotiate with the second device to change to the reduced the link speed (block 818). The first device may further reduce the amount of the resources utilized for operating the link corresponding with the reduced link speed (block 820). However, if the period of the inactivity does not exceed the threshold, then the first device may maintain the optimal link speed for communicating on the link (block 822).

It is understood that the specific order or hierarchy of steps in the processes disclosed is an illustration of exemplary approaches. The specific order or hierarchy of steps in the processes may be rearranged based upon design preferences. The accompanying method claims present elements of the various steps in a sample order, and are not meant to be limited to the specific order or hierarchy presented.

The link speed control systems for power optimization according to aspects disclosed herein may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The arbiters, master devices, and slave devices described herein may be employed in any circuit, hardware component, IC, or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality.

How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an ASIC, a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in RAM, flash memory, ROM, Electrically Programmable ROM (EPROM), EEPROM, registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A first device for changing a link speed, comprising:
a communication interface circuit; and
a processing circuit configured to:
establish a link with a second device via the communication interface circuit;
detect one or more conditions affecting a link speed, wherein each of the one or more conditions is assigned a weight;
select an optimal link speed for communicating on the link based on the one or more conditions by evaluating a priority of each condition according to the weight assigned to each condition; and
negotiate with the second device to change to the optimal link speed for communicating on the link.

2. The first device of claim 1, wherein the one or more conditions comprise at least one of:
battery level information;
modem configuration information;
maximum available bandwidth information; and
an applications processor vote.

3. The first device of claim 1, wherein the processing circuit is further configured to assign the weight to each of the one or more conditions.

4. The first device of claim 1, wherein the processing circuit is configured to select the optimal link speed based on an individual condition or a combination of conditions.

5. The first device of claim 1, wherein the processing circuit is further configured to:
reduce or increase an amount of resources utilized for operating the link corresponding with the optimal link speed.

6. The first device of claim 5, wherein the resources comprise at least one of:
voltage resources; and
frequency resources.

7. The first device of claim 1, wherein the processing circuit is configured to negotiate with the second device to change to the optimal link speed by advertising the optimal link speed to the second device.

8. The first device of claim 1, wherein the processing circuit is further configured to:
measure a period of inactivity on the link;
select a reduced link speed for communicating on the link when the period of the inactivity exceeds a threshold;
negotiate with the second device to change to the reduced link speed; and
reduce an amount of resources utilized for operating the link corresponding with the reduced link speed.

9. The first device of claim 8, wherein the processing circuit is further configured to:
maintain the optimal link speed for communicating on the link when the period of the inactivity does not exceed the threshold.

10. A method of changing a link speed at a first device, comprising:
establishing a link with a second device;
detecting one or more conditions affecting a link speed, wherein each of the one or more conditions is assigned a weight;
selecting an optimal link speed for communicating on the link based on the one or more conditions by evaluating a priority of each condition according to the weight assigned to each condition; and
negotiating with the second device to change to the optimal link speed for communicating on the link.

11. The method of claim 10, wherein the one or more conditions comprise at least one of:
battery level information;
modem configuration information;
maximum available bandwidth information; and
an applications processor vote.

12. The method of claim 10, further comprising assigning the weight to each of the one or more conditions.

13. The method of claim 10, wherein the optimal link speed is selected based on an individual condition or a combination of conditions.

14. The method of claim 10, further comprising:
reducing or increasing an amount of resources utilized for operating the link corresponding with the optimal link speed.

15. The method of claim 14, wherein the resources comprise at least one of:
voltage resources; and
frequency resources.

16. The method of claim 10, wherein negotiating with the second device to change to the optimal link speed includes advertising the optimal link speed to the second device.

17. The method of claim 10, further comprising:
measuring a period of inactivity on the link;
selecting a reduced link speed for communicating on the link when the period of the inactivity exceeds a threshold;
negotiating with the second device to change to the reduced link speed; and
reducing an amount of resources utilized for operating the link corresponding with the reduced link speed.

18. The method of claim 17, further comprising:
maintaining the optimal link speed for communicating on the link when the period of the inactivity does not exceed the threshold.

19. A first device for changing a link speed, comprising:
a communication interface circuit; and
a processing circuit configured to, via the communication interface circuit:
establish a link with a second device;
utilize an amount of resources for operating the link, the amount of the resources corresponding to a link speed;
negotiate with the second device to change to a low system throughput state based on at least one condition;
reduce the link speed based on the change to the low system throughput state; and
reduce the amount of the resources utilized for operating the link corresponding with the reduced link speed.

20. The first device of claim 19, wherein the processing circuit is configured to reduce the link speed by advertising the reduced link speed to the second device.

21. The first device of claim 19, wherein the resources comprise at least one of:
voltage resources; and
frequency resources.

22. The first device of claim 19, wherein the processing circuit is configured to negotiate with the second device to change to the low system throughput state by:
measuring a period of inactivity on the link; and
negotiating with the second device to change to the low system throughput state when the period of the inactivity exceeds a threshold.

23. The first device of claim 22, wherein the processing circuit is further configured to negotiate with the second device to change to a high system throughput state when the period of the inactivity is below the threshold.

24. The first device of claim 19, wherein the processing circuit is configured to negotiate with the second device to change to the low system throughput state by:
determining a link state comprising at least one of a current link bandwidth requirement and a link connection status; and
negotiating with the second device to change to the low system throughput state based on the link state.

25. A method of changing a link speed at a first device, comprising:
establishing a link with a second device;
utilizing an amount of resources for operating the link, the amount of the resources corresponding to a link speed;
negotiating with the second device to change to a low system throughput state based on at least one condition;
reducing the link speed based on the change to the low system throughput state; and
reducing the amount of the resources utilized for operating the link corresponding with the reduced link speed.

26. The method of claim 25, wherein reducing the link speed comprises advertising the reduced link speed to the second device.

27. The method of claim 25, wherein the resources comprise at least one of:
voltage resources; and
frequency resources.

28. The method of claim 25, wherein negotiating with the second device to change to the low system throughput state comprises:
measuring a period of inactivity on the link; and
negotiating with the second device to change to the low system throughput state when the period of the inactivity exceeds a threshold.

29. The method of claim 28, further comprising negotiating with the second device to change to a high system throughput state when the period of the inactivity is below the threshold.

30. The method of claim 25, wherein negotiating with the second device to change to the low system throughput state comprises:
determining a link state comprising at least one of a current link bandwidth requirement and a link connection status; and
negotiating with the second device to change to the low system throughput state based on the link state.

31. A first device for changing a link speed, comprising:
a memory; and
a processing circuit coupled to the memory and configured to:
establish a link with a second device;
utilize an amount of resources for operating the link, the amount of the resources corresponding to a link speed;
negotiate with the second device to change to a high system throughput state based on at least one condition;
increase the amount of the resources utilized for operating the link based on the change to the high system throughput state; and
increase the link speed corresponding with the increased amount of the resources.

32. The first device of claim 31, wherein the processing circuit is configured to increase the link speed by advertising the increased link speed to the second device.

33. The first device of claim 31, wherein the resources comprise at least one of:
voltage resources; and
frequency resources.

34. The first device of claim 31, wherein the processing circuit is configured to negotiate with the second device to change to the high system throughput state by receiving a request to change to the high system throughput state.

35. The first device of claim 31, wherein the processing circuit is configured to negotiate with the second device to change to the high system throughput state by:
measuring a period of inactivity on the link; and
negotiating with the second device to change to the high system throughput state when the period of the inactivity is below a threshold.

36. The first device of claim 35, wherein the processing circuit is further configured to negotiate with the second device to change to a low system throughput state when the period of the inactivity exceeds the threshold.

37. The first device of claim 31, wherein the processing circuit is configured to negotiate with the second device to change to the high system throughput state by:
determining a link state comprising at least one of a current link bandwidth requirement and a link connection status; and
negotiating with the second device to change to the high system throughput state based on the link state.

38. A method for changing a link speed of a first device, comprising:
establishing a link with a second device;
utilizing an amount of resources for operating the link, the amount of the resources corresponding to a link speed;
negotiating with the second device to change to a high system throughput state based on at least one condition;
increasing the amount of the resources utilized for operating the link based on the change to the high system throughput state; and
increasing the link speed corresponding with the increased amount of the resources.

39. The method of claim 38, wherein increasing the link speed comprises advertising the increased link speed to the second device.

40. The method of claim 38, wherein the resources comprise at least one of:
voltage resources; and
frequency resources.

41. The method of claim 38, wherein negotiating with the second device to change to the high system throughput state comprises receiving a request to change to the high system throughput state.

42. The method of claim 38, wherein negotiating with the second device to change to the high system throughput state comprises:
measuring a period of inactivity on the link; and
negotiating with the second device to change to the high system throughput state when the period of the inactivity is below a threshold.

43. The method of claim 42, further comprising negotiating with the second device to change to a low system throughput state when the period of the inactivity exceeds the threshold.

44. The method of claim 38, wherein negotiating with the second device to change to the high system throughput state comprises:
determining a link state comprising at least one of a current link bandwidth requirement and a link connection status; and
negotiating with the second device to change to the high system throughput state based on the link state.

45. An integrated circuit (IC) comprising:
resource circuitry;
a port configured to be coupled to a communication link and operatively coupled to the resource circuitry, wherein the resource circuitry is used to control aspects of communication over the communication link; and
a host configured to adjust activity over the communication link based on one or more conditions affecting the communication link.

46. The IC of claim 45, wherein the host is configured to adjust the activity over the communication link by increasing or decreasing a link speed.

47. The IC of claim 45, wherein the one or more conditions are selected from the group consisting of: inactivity, battery level, modem activity, wireless activity, and applications processor activity.

48. The IC of claim 47, wherein the one or more conditions of the group are weighted when considered by the host.

49. The IC of claim 45, wherein the host is configured to adjust dynamically based on changes in conditions.

50. The IC of claim 45, wherein the resource circuitry comprises voltage and frequency resource circuitry.

51. The IC of claim 45, wherein the port comprises a Peripheral Component Interconnect (PCI) express (PCIe) port.
